(19) United States
(12) Patent Application Publication
(10) Pub. No.: US 2006/0200857 A1
(43) Pub. Date: Sep. 7, 2006

(54) Certificate acquisition system, certificate acquisition method, management communication apparatus, certification authority, and computer readable recording medium

(76) Inventor: Tomofumi Yokota, Kawasaki-shi (JP)

Correspondence Address: GAUTHIER & CONNORS, LLP, 225 FRANKLIN STREET, BOSTON, MA, 02110, US

(21) Appl. No.: 11/357,820

(22) Filed: Feb. 17, 2006

(30) Foreign Application Priority Data
Mar. 7, 2005 (JP) 2005-61734

(51) Int. Cl. H04L 9/32

(52) U.S. Cl. 726/6

(57) ABSTRACT

A certificate acquisition system which includes a management communication apparatus that connects to a device and also connects via a network to a management center for managing the device, acquires management information from the device, sends the management information to the management center, and requests for a digital certificate to a certification authority, the system having: a registration information memory section which pre-registers identification information for a management communication apparatus and a device that should be connected; an identification information acquisition section that acquires device identification information from the device; a certificate issuance request section that requests the certification authority to issue the digital certificate, the request including the acquired device identification information and management communication apparatus identification information; an issuance request receiving section that receives the request to issue the digital certificate; a certificate issuance section that authenticates the management communication apparatus by collating the identification information included in the request and the pre-registered identification information, and issues the digital certificate if the authentication is successful; and a certificate acquisition section that acquires from the certification authority the issued digital certificate if the authentication is successful.

### PRIORITY INFORMATION

This application claims priority to Japanese Patent Application No. 2005-61734, filed on Mar. 7, 2005, which is incorporated herein by reference in its entirety.

### BACKGROUND

1. Technical Field

This invention relates to a certificate acquisition system having a management communication apparatus that connects to a device and also connects via a network to a management center for remotely managing the device and that acquires management information from the device and sends the information to the management center, and a certificate authority that issues a digital certificate.

2. Related Art

A remote management system in which a management center remotely manages a printing apparatus via a network has been proposed as a system for managing a printing apparatus such as a copier, printer, facsimile, digital multifunction machine, and so forth. In the remote management system, an optional management communication apparatus is externally attached to the printing apparatus and various types of information (regarding metered values, faults, paper sheets, consumables, operating state, job, and so forth) are sent to the management center from the management communication apparatus via the network.

If the above-mentioned remote management system has a configuration for performing communications between the management communication apparatus and the management center via an open network, such as the Internet, the communication between the management communication apparatus and the management center is exposed to the risk of eavesdropping or alteration. Furthermore, since the management center offers services on the Internet, it is exposed to the risk of various attacks.

To avoid these attacks, it is preferable to apply security techniques using digital certificates, such as SSL with client authentication, to communications between the management communication apparatus and the management center. It is necessary to install a digital certificate in the management communication apparatus when using SSL with client authentication.

Generally, the installation of a digital certificate to a personal computer (PC) or a cellular telephone is performed in the following procedure. First, a user (such as of a PC) requests the issuance of a digital certificate from a certification authority. Next, the certification authority, after confirming the identity of the user through any appropriate method, such as in person, postal mail or electronic mail, issues the digital certificate. Finally, the user acquires and installs (such as to a PC) the issued digital certificate. The digital certificate is manually acquired in this manner by the user because it is considered necessary to authenticate the origin of the issuance request in the issuance process of the digital certificate.

If the above-mentioned general procedure is applied as is to a remote management system, the user or customer engineer (CE) would acquire the digital certificate from a certification authority and install it in the management communication apparatus. In this case, the burden on the user is large as the user must perform the issuance request, authentication procedure, acquisition, and installation.

### SUMMARY

According to one aspect of the present invention, there is provided a certificate acquisition system which includes a management communication apparatus that connects to a device and also connects via a network to a management center for managing the device, acquires management information from the device, sends the management information to the management center, and requests for a digital certificate to a certification authority, the system having: a registration information memory section which pre-registers identification information for a management communication apparatus and a device that should be connected; an identification information acquisition section that acquires device identification information from the device;a certificate issuance request section that requests the certification authority to issue the digital certificate, the request including the acquired device identification information and management communication apparatus identification information; an issuance request receiving section that receives the request to issue the digital certificate; a certificate issuance section that authenticates the management communication apparatus by collating the identification information included in the request and the pre-registered identification information, and issues the digital certificate if the authentication is successful; and a certificate acquisition section that acquires from the certification authority the issued digital certificate if the authentication is successful.

According to another aspect of the present invention, there is provided a certificate acquisition method in a system that includes a management communication apparatus that connects to a device and also connects via a network to a management center for managing the device, sends management information of the device to the management center, and acquires a digital certificate from a certificate authority, the method having: acquiring device identification information from the device; requesting the certification authority to issue a digital certificate, the request including the acquired device identification information and management communication apparatus identification information; performing authentication of the management communication apparatus by collating the identification information included in the request and identification information for the management communication apparatus and the device that should be connected, which has been pre-registered in the certification authority; and issuing a digital certificate if the authentication is successful.

According to another aspect of the present invention, there is provided a management communication apparatus, which connects to a device and also connects via a network to a management center for managing the device, acquires management information from the device, and sends the management information to the management center, having: an identification information acquisition section that acquires device identification information from the device; a certificate issuance request section that requests the certification authority to issue the digital certificate, the request including the acquired device identification information and management communication apparatus identification information; and a certificate acquisition section that acquires from the certification authority the digital certificate that is issued by the certification authority if the authentication is successful.

According to another aspect of the present invention, there is provided a certification authority that issues a digital certificate to a management communication apparatus, which connects to a device and also connects via a network to a management center for managing the device, acquires management information from the device, and sends the management information to the management center, the certification authority having: a registration information memory section which pre-registers identification information for a management communication apparatus and a device that should be connected; an issuance request receiving section that receives a request to issue the digital certificate, the request including management communication apparatus identification information and device identification information from the management communication apparatus; and a certificate issuance section that authenticates the management communication apparatus by collating the identification information included in the request and the pre-registered identification information, and issues the digital certificate if the authentication is successful.

According to another aspect of the present invention, there is provided a computer readable storage medium storing a program to be executed on a management communication apparatus, which connects to a device and also connects via a network to a management center for managing the device, acquires management information from the device, and sends the management information to the management center, the program causes the management communication apparatus to perform a function having: acquiring device identification information from a device; requesting a certification authority to issue the digital certificate, the request including the acquired device identification information and management communication apparatus identification information; and receiving from the certification authority the digital certificate that is issued by the certification authority if the authentication is successful.

### BRIEF DESCRIPTION OF THE DRAWINGS

Embodiments of this invention will be described in detail based on the following figures, wherein:

FIG. 1 is a block diagram showing a configuration of a certificate acquisition system relating to an embodiment;

FIG. 2 is a block diagram showing a functional configuration of a management communication apparatus and a certification authority;

FIG. 3 illustrates an example of a certificate acquisition procedure (first example procedure) in the certificate acquisition system;

FIG. 4 illustrates another example of a certificate acquisition procedure (second example procedure) in the certificate acquisition system; and

FIG. 5 illustrates another example of a certificate acquisition procedure (third example procedure) in the certificate acquisition system.

### DETAILED DESCRIPTION

Embodiments of this invention will be described hereinafter with reference to the attached drawings.

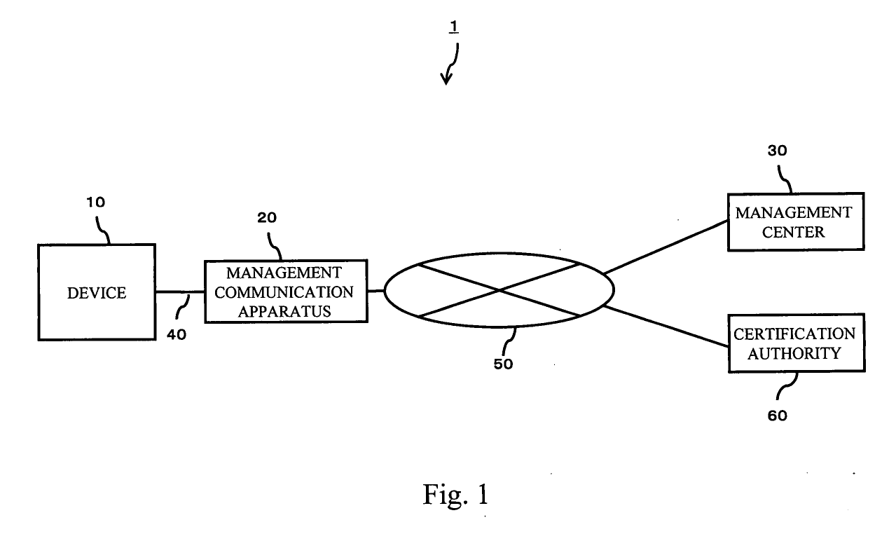

FIG. 1 is a block diagram showing a configuration of a certificate acquisition system 1 relating to the embodiment. In a remote management system that is configured to include a device 10, a management communication apparatus 20, and a management center 30, the certificate acquisition system 1 reduces the burden, such as on a user, regarding installation of a digital certificate (referred to hereinafter as certificate) to the management communication apparatus 20.

Remote Management System

First, the remote management system will be described. In FIG. 1, the remote management system has the device 10, the management communication apparatus 20, and the management center 30.

The device 10 is the apparatus to be managed in the remote management system. Here, the device 10 is a printing apparatus, such as a copier, printer, facsimile, digital multifunction machine, and so forth, for forming images on a recording medium, such as paper, by an appropriate printing system, such as a electrophotographic printing system or an inkjet system.

The management communication apparatus 20 is an optional apparatus to make possible the remote management of the device 10 and is externally attached to the device 10 in case a user requests to remote management services. Since the remote management services are optional services to be provided as requested by the user, the device 10 is not built in with functions for remote management services.

The management communication apparatus 20 is connected to the device 10 via a communication cable 40, such as a serial cable, and is also connected to the management center 30 via a network 50, such as the Internet. For example, in dialup (modem) access, the management communication apparatus 20 connects to the management center 30 via a modem, a public telephone line, an Internet service provider (ISP), and the Internet. Furthermore, in wired LAN access, the management communication apparatus 20 is connected to the management center 30 via a wired LAN, a firewall, and the Internet. Furthermore, in wireless access, the management communication apparatus 20 connects to the management center 30 via a cellular telephone network.

The management communication apparatus 20 acquires management information, which is to be used in the management of the device 10, from the device 10 via the communication cable 40 and sends to the information to the management center 30 via the network 50. Here, the management information includes various types of information, such as the operating state of the device 10, and relates to the number of printed sheets (metered count), faults, paper sheets, consumables, operating state, and so forth.

The management center 3.0 is a computer system for remotely managing the device 10 via the network 50 and the management communication apparatus 20. For example, the management center 30 is provided with an accounting server for receiving a metered count for the device 10 from the management communication apparatus 20 and performing a predetermined accounting process on the basis of the metered count.

Although only one set composed of the device 10 and the management communication apparatus 20 is shown in FIG. 1, it should be noted that there may be multiple sets.

In the above-mentioned remote management system, since the communication between the management communication apparatus 20 and the management center 30 is performed via the network 50, the communication is exposed to the risk of eavesdropping or alteration. Furthermore, since the management center 30 provides services over the network, it is exposed to the risk of various attacks.

In this embodiment, the management communication apparatus 20 and the management center 30 uses a security technique using a certificate, such as for SSL with client authentication, in the communication to protect against the above-mentioned risks.

Certificate Acquisition System

In the case where SSL with client authentication is used in the above-mentioned remote management system, it is necessary for a certificate to be installed to the management communication apparatus 20. If the installation of the certificate to the management communication apparatus 20 is something to be performed by a user or CE, this places a burden on the user or CE. To eliminate this burden, such as on the user, in the certificate acquisition system 1 relating to this embodiment, the management communication apparatus 20 requests the issuance of a certificate by presenting authentication information to a certification authority 60 and then acquires a certificate from the certification authority 60.

In FIG. 1, the certificate acquisition system 1 is configured mainly from the management communication apparatus 20 and the certification authority 60. The certification authority 60 is a certificate issuance apparatus for issuing a certificate in response to an external request and is implemented, for example, in a computer system. The management communication apparatus 20 and the certification authority 60 are connected to each other via the network 50.

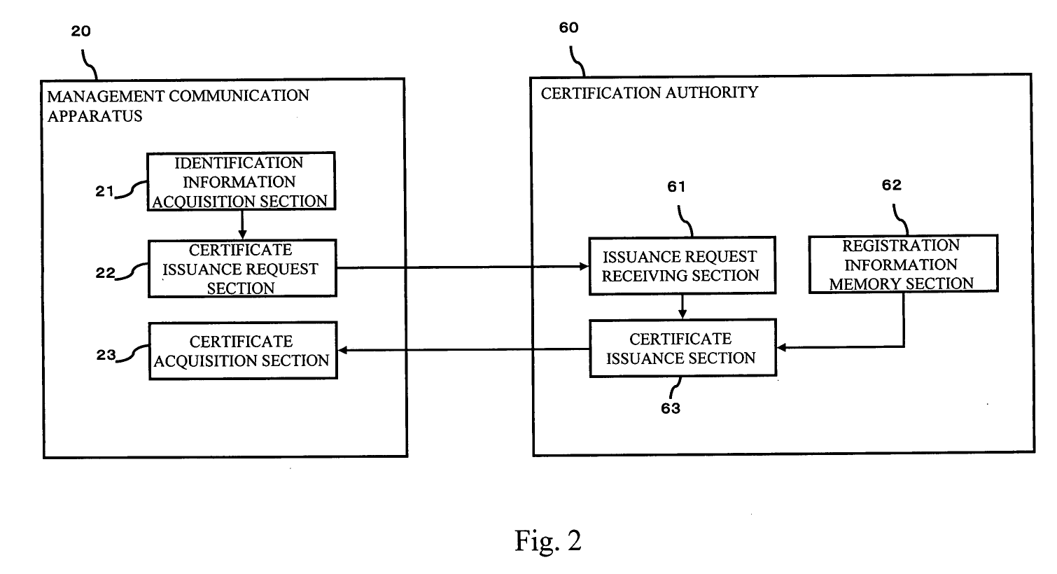

FIG. 2 is a block diagram showing a functional configuration of the management communication apparatus 20 and the certification authority 60. The configuration of the certificate acquisition system 1 will be described more exactly hereinafter with reference to FIG. 2.

The management communication apparatus 20 has an identification information acquisition section 21, a certificate issuance request section 22, and a certificate acquisition section 23.

The identification information acquisition section 21 acquires identification information (appropriately referred to hereinafter as “device identification information”) for the device 10 from the device 10. The device identification information identifies the device 10 with such information as model name, serial number or component information (software version, component information for optional devices, such as finisher or high capacity tray), or a combination of these.

As information to be used in the authentication of the management communication apparatus 20 in the certification authority 60, the certificate issuance request section 22 presents authentication information showing a combination of identification information (appropriately referred to hereinafter as “management communication apparatus identification information”) for the management communication apparatus 20 and device identification information that was acquired from the identification information acquisition section 21, and requests the certification authority 60 to issue a certificate. The management communication apparatus identification information is preset in the management communication apparatus 20 for identifying the management communication apparatus 20 and may be any type of information provided the management communication apparatus 20 can be authenticated. For example, the information may be a serial number or MAC address of the management communication apparatus 20.

The certificate acquisition section 23 acquires a certificate that is issued by the certification authority 60 if authentication was successful on the basis of the authentication information.

The above-mentioned identification information acquisition section 21, certificate issuance request section 22, and certificate acquisition section 23 may be implemented in any mode, for example, in a program recorded on a recording medium, such as ROM, and executed by a CPU.

On the other hand, the certification authority 60 has an issuance request receiving section 61, a registration information memory section 62, and a certificate issuance section 63.

The issuance request receiving section 61 receives a request for the issuance of a certificate accompanying the presentation of the above-mentioned authentication information from the management communication apparatus 20.

The registration information memory section 62 is an appropriate storage medium which is registered registration information showing a combination of identification information for the management communication apparatus 20 and the device 10 that should be connected.

The certificate issuance section 63 performs authentication of the management communication apparatus 20 by collating the authentication information presented from the management communication apparatus 20 and the registration information that is registered in the registration information memory section 62. If this authentication is successful, a certificate is issued to the management communication apparatus 20.

Authentication of the management communication apparatus 20 in this embodiment will be described here. Although a manufacturer or seller knows information on which management communication apparatus 20 is to be connected to which device 10, a third party does not. In this embodiment, the validity of the management communication apparatus 20 is confirmed by judging whether or not the management communication apparatus 20 is connected to the correct device 10. Therefore, the authentication information and the registration information may be any type of information provided the management communication apparatus 20 can be authenticated by the certification authority 60 judging the validity of the connected combination.

In the above-mentioned configuration, from the viewpoint of improving the security level, it is preferable for the authentication information and the registration information to indicate a combination of management communication apparatus identification information, device identification information, and secret information (shared secret), such as a license key to be shared between the management communication apparatus 20 and the certification authority 60. In this case, judging the validity of the combination of the management communication apparatus identification information, the device identification information, and the secret information performs the authentication of the management communication apparatus 20.

Furthermore, in the above-mentioned configuration, a key pair composed of a private key and a public key may be generated at the management communication apparatus 20 side or at the certification authority 60 side.

The above-mentioned issuance request receiving section 61 and the certificate issuance section 63 may be implemented in any mode, for example, in a program recorded on a recording medium, such as ROM, and executed by a CPU.

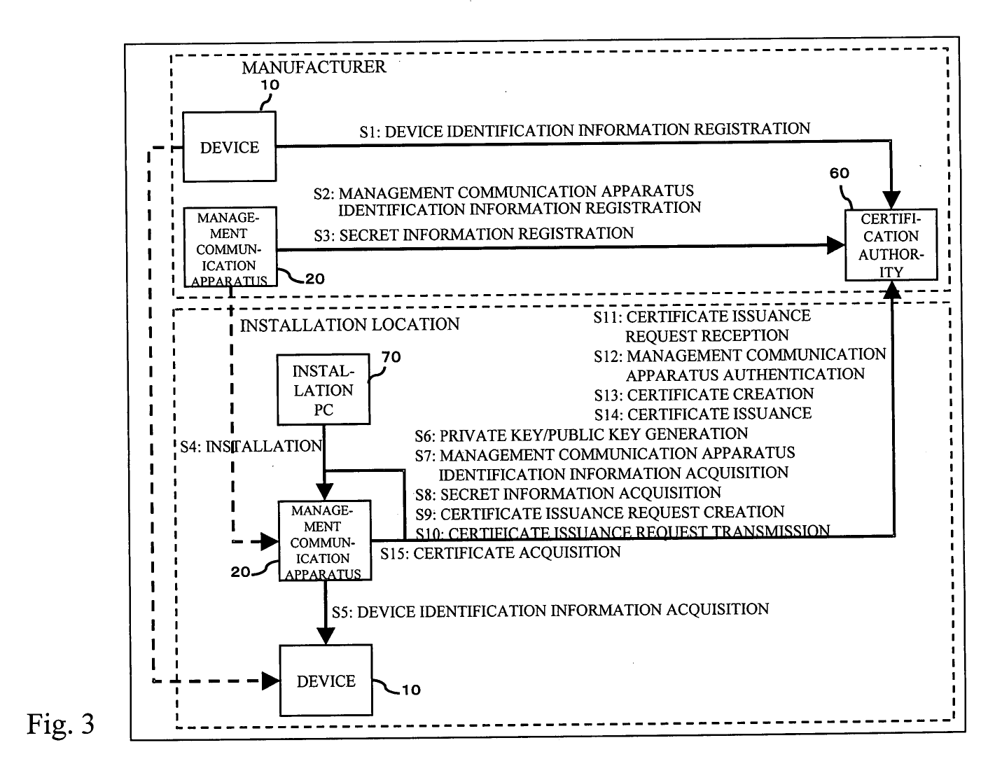

FIG. 3 to FIG. 5 respectively illustrates an example of the certificate acquisition procedure in the certificate acquisition system 1. The certificate acquisition procedure will be divided into the first to third example procedures and described more exactly hereinafter with reference to FIG. 3 to FIG. 5.

### FIRST EXAMPLE PROCEDURE

The first example procedure is shown in FIG. 3 where an installation process for an installation PC triggers the start of the certificate acquisition process by the management communication apparatus 20 and a pair of keys is generated at the management communication apparatus 20. This procedure may be used during installation of the management communication apparatus 20.

In step S1, the device manufacturer registers the identification information (device identification information) for the device 10 into the certification authority 60.

In step S2, the management communication apparatus manufacturer registers to the certification authority 60 the identification information (management communication apparatus identification information) for the management communication apparatus and the identification information for the device that should be connected. The management communication apparatus manufacturer may be identical to or different from the device manufacturer.

In step S3, the management communication apparatus manufacturer registers secret information, which has been set in the management communication apparatus 20, in the certification authority 60.

From the above-mentioned steps S1 to S3, combination information (registration information) in which are mapped management communication apparatus identification information, device identification information, and secret information is registered in the certification authority 60. Although the device 10 and the management communication apparatus 20 are shown with arrows connected to the certification authority 60 in FIG. 3, in actuality, they may or not be connected.

The device 10 and the management communication apparatus 20 are moved to an actual installation location (such as a customer location) as shown by the dashed arrows in FIG. 3.

In step S4, the CE connects an installation PC 70 to the management communication apparatus 20 and issues an installation command from the installation PC 70 to the management communication apparatus 20. In this example procedure, the following certificate acquisition process by the management communication apparatus 20 begins with the installation command.

In step S5, the management communication apparatus 20 acquires device identification information from the device 10 that is connected.

In step S6, the management communication apparatus 20 generates a key pair composed of a private key and a public key.

In step S7, the management communication apparatus 20 acquires its own identification information (management communication apparatus identification information).

In step S8, the management communication apparatus 20 acquires the secret information that it has been set with.

In step S9, the management communication apparatus 20 creates a certificate issuance request based on the device identification information, management communication apparatus identification information, private key, public key, and secret information. More specifically, the management communication apparatus 20 creates issuance request information which include the management communication apparatus identification information, device identification information, and the public key. Next, using the private key, the management communication apparatus 20 creates a signature for the issuance request information, and adding the created signature to the issuance request information, creates signed issuance request information. Next, secret information is added to the signed issuance request information and a hash value is calculated by applying a predetermined hash function to the obtained information. Then, the hash value is added to the signed issuance request information to generate a certificate issuance request. Specifically, the certificate issuance request includes management communication apparatus identification information, device identification information, the public key, the signature, and the hash value.

In step S10, the management communication apparatus 20 transmits the certificate issuance request to the certification authority 60.

In step S11, the certification authority 60 receives the certificate issuance request from the management communication apparatus 20.

In step S12, the certification authority 60 performs authentication of the management communication apparatus 20 by using the pre-registered management communication apparatus identification information, device identification information, and secret information.

More specifically, the certification authority 60 references the registration information memory section 62 and identifies the secret information corresponding to the management communication apparatus identification information that is included in the certificate issuance request. Then, using the identified secret information, verification of the hash value which is included in the certificate issuance request is performed. Specifically, the identified secret information is added to the signed issuance request information to be included in the certificate issuance request and a hash value is calculated by applying a predetermined hash function to the obtained information. Then, the calculated hash value and the hash value to be included in the certificate issuance request are collated. This hash value verification confirms the validity of the secret information. Therefore, a certificate is not issued if the verification fails.

If the hash value verification succeeds, the certification authority 60 performs verification of the signature that is included in the certificate issuance request by using the public key that is included in the certificate issuance request. Specifically, the information obtained by decrypting the signature with the public key is compared with the issuance request information that is included in the certificate issuance request.

If the signature verification succeeds, the certification authority 60 collates the combination of the management communication apparatus identification information and device identification information that are included in the certificate issuance request with the pre-registered combination of the management communication apparatus identification information and device identification information. The collation of these combinations confirms the validity of the combination of the management communication apparatus 20 and the device 10. Therefore, the certificate is not issued if the collation fails. On the other hand, if the collation succeeds, the execution proceeds to step S13.

In step S13, the certification authority 60 creates a certificate by adding the signature of the certification authority 60 to the information that includes the public key and the management communication apparatus identification information that is included in the certificate issuance request.

In step S14, the certification authority 60 transmits the created certificate to the management communication apparatus 20.

In step S15, the management communication apparatus 20 receives from the certification authority 60 the certificate that was issued from the certification authority 60 in response to the certificate issuance request.

Although secret information was used in this example, this secret information can be omitted. If the secret information is omitted, the above-mentioned steps S3 and S8 are omitted. Furthermore, in the above-mentioned step S9, the hash value is not calculated and the signed issuance request information becomes the certificate issuance request. Moreover, in the above-mentioned step S12, the verification of the hash value is omitted.

### SECOND EXAMPLE PROCEDURE

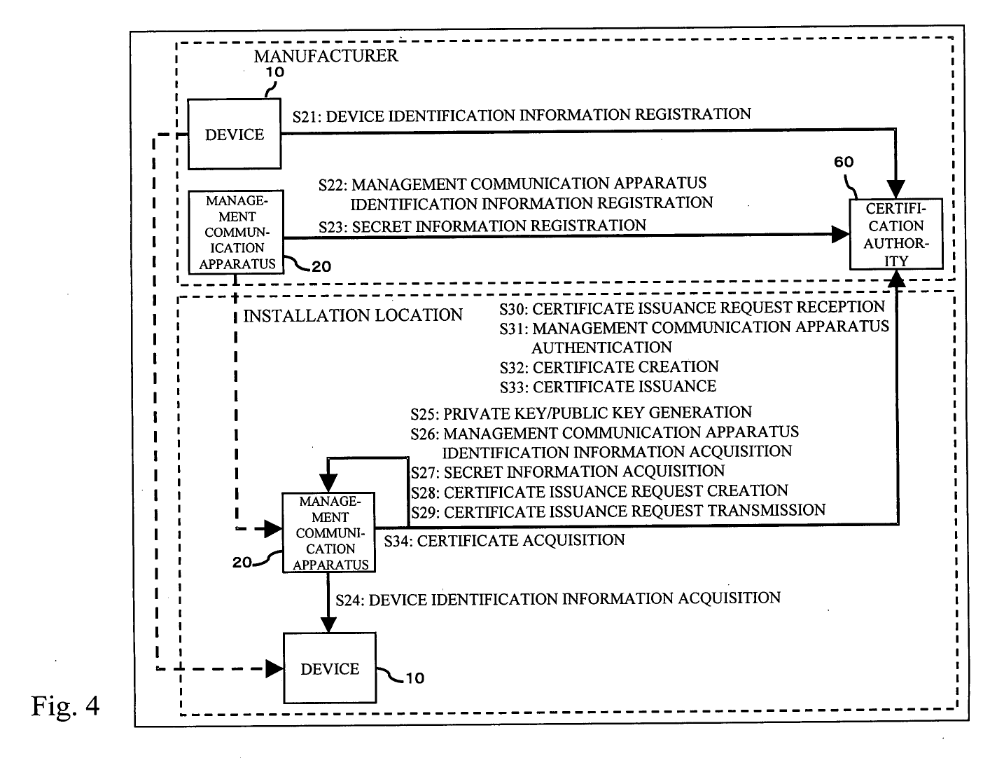

The second example procedure is shown in FIG. 4 where the management communication apparatus 20 automatically begins the certificate acquisition process and the key pair is generated at the management communication apparatus 20. This procedure may be used during certificate renewal.

Steps S21 to S23 are identical to the above-mentioned steps S1 to S3. Subsequent to step S23, the device 10 and the management communication apparatus 20 are moved to the actual installation location (such as a customer location) as shown by the dashed arrows in FIG. 4.

In this procedure, there is no trigger, such as the installation command for the installation PC, and the management communication apparatus 20 automatically begins the certificate acquisition process. For example, the management communication apparatus 20 automatically begins the process when power is turned on, or begins the process periodically.

Steps S24 to S34 are identical to the above-mentioned steps S5 to S15.

### THIRD EXAMPLE PROCEDURE

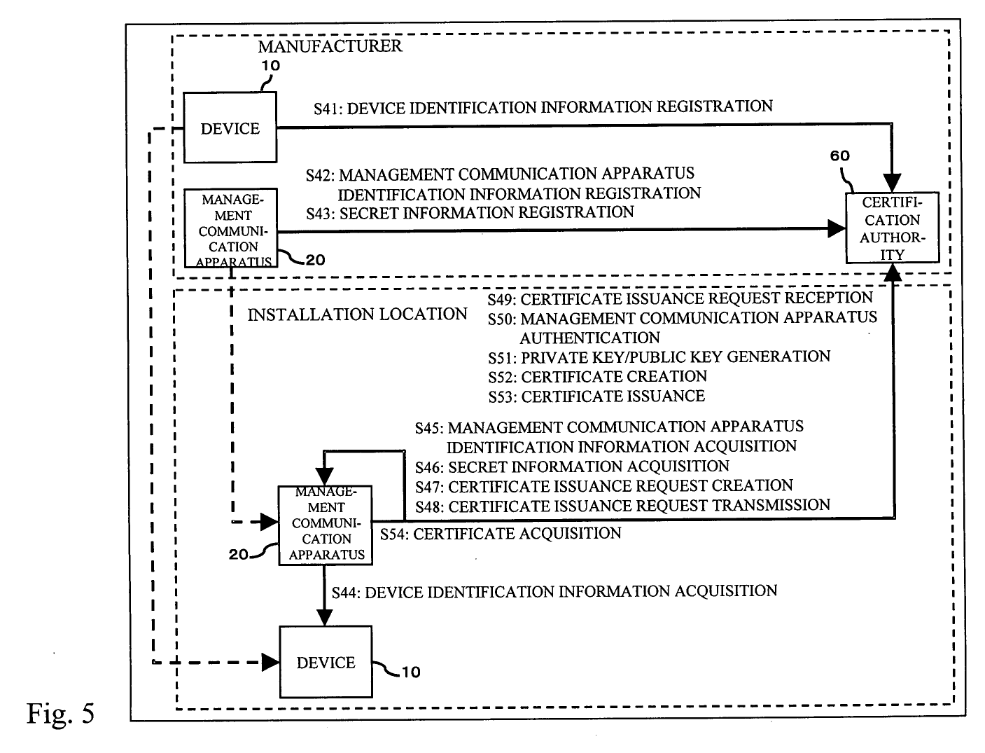

The third example procedure is shown in FIG. 5 where the management communication apparatus 20 automatically begins the certificate acquisition process and the key pair is generated at the certification authority 60. This procedure may be used during certificate renewal.

Steps S41 to S43 are identical to the above-mentioned steps S1 to S3. Subsequent to step S43, the device 10 and the management communication apparatus 20 are moved to the actual installation location (such as a customer location) as shown by the dashed arrows in FIG. 5. The management communication apparatus 20 then automatically begins the certificate acquisition process in a similar manner to the above-mentioned second example procedure.

In step S44, the management communication apparatus 20 acquires device identification information from the device 10 that is connected.

In step S45, the management communication apparatus 20 acquires its own identification information (management communication apparatus identification information).

In step S46, the management communication apparatus 20 acquires the secret information that it has been set with.

In step S47, the management communication apparatus 20 creates a certificate issuance request from the device identification information, management communication apparatus identification information, and secret information. More specifically, the management communication apparatus 20 creates issuance request information which include the management communication apparatus identification information and the device identification information. Next, secret information is added to the issuance request information and a hash value is calculated by applying a predetermined hash function to the obtained information. The hash value is then added to the issuance request information to generate the certificate issuance request. Specifically, the certificate issuance request includes the management communication apparatus, the device identification information, and the hash value.

In step S48, the management communication apparatus 20 transmits the certificate issuance request to the certification authority 60.

In step S49, the certification authority 60 receives the certificate issuance request from the management communication apparatus 20.

In step S50, the certification authority 60 performs authentication of the management communication apparatus 20 by using the pre-registered management communication apparatus identification information, device identification information, and secret information.

More specifically, the certification authority 60 references the registration information memory section 62 and identifies the secret information corresponding to the management communication apparatus identification information that is included in the certificate issuance request. Then, using the identified secret information, verification of the hash value which is included in the certificate issuance request is performed. Specifically, the identified secret information is added to the issuance request information which is included in the certificate issuance request and a hash value is calculated by applying a predetermined hash function to the obtained information. Then, the calculated hash value and the hash value that is included in the certificate issuance request are collated. This hash value verification confirms the validity of the secret information. Therefore, the certificate is not issued if the verification fails.

If the hash value verification succeeds, the certification authority 60 collates the combination of the management communication apparatus identification information and the device identification information that are included in the certificate issuance request with the combination of the pre-registered management communication apparatus identification information and device identification information. The verification of this combination confirms the validity of the combination of the management communication apparatus 20 and the device 10. Therefore, the certificate is not issued if the collation fails. On the other hand, if the collation succeeds, the execution proceeds to step S51.

In step S51, the certification authority 60 generates a key pair composed of a private key and a public key.

In step S52, the certification authority 60 creates a certificate by adding the signature of the certification authority 60 to the information that includes the generated public key and the management communication apparatus identification information that is included in the certificate issuance request.

In step S53, the certification authority 60 transmits the created certificate to the management communication apparatus 20.

In step S54, the management communication apparatus 20 receives from the certification authority 60 the certificate that was issued from the certification authority 60 in response to the certificate issuance request.

The private key that was generated by the certification authority 60 is sent to the management communication apparatus 20 from the certification authority 60 with an appropriate key delivery system. Since the certification authority 60 can store the private key in this example procedure, a problem can be avoided where it becomes impossible to decode the encrypted data if the private key within the management communication apparatus 20 is lost.

As described above, in this embodiment, the management communication apparatus 20 performs acquisition of the certificate by presenting its own authentication information to the certification authority 60. For this reason, according to this embodiment, the burden, such as on the user, regarding the installation of the certificate to the management communication apparatus 20 can be reduced or eliminated.

Furthermore, since the combination of the management communication apparatus identification information and device identification information is used in the authentication, a simple and secure authentication can be implemented. Furthermore, the use of the management communication apparatus 20 can be prevented in the case of an unplanned connection of the device 10.

Furthermore, since the combination of the management communication apparatus identification information, device identification information, and secret information is used in the authentication, a more secure authentication can be implemented. Moreover, the secret information may include control information with regard to permission as to what type of certificate is to be issued so that the control of the permission level becomes simple.

It should be understood that the present invention is not intended to be limited by the above-mentioned embodiments and various modifications can be made within the scope of and without deviating from the spirit of the invention.

For example, the device 10 is not limited to a printing apparatus and may be another type of controlled device, such as a network home appliance or a vending machine.

Furthermore, the connection of the device 10 and the management communication apparatus 20 is not limited to a wired connection and may be a wireless connection.

Furthermore, in the above-mentioned example procedures, the authentication information is included in the certificate issuance request and the presentation of the authentication information and the issuance request are performed simultaneously. However, they need not be performed simultaneously. For example, after a certificate issuance request that does not include authentication information is transmitted, the management communication apparatus 20 may transmit authentication information to the certification authority 60 in response to a presentation request from the certification authority 60.

According to an aspect of the present invention, there is provided a certificate acquisition system which includes a management communication apparatus that connects to a device and also connects via a network to a management center for managing the device, acquires management information from the device, sends the management information to the management center, and requests for a digital certificate to a certification authority, the system having: a registration information memory section which pre-registers identification information for a management communication apparatus and a device that should be connected; an identification information acquisition section that acquires device identification information from the device; a certificate issuance request section that requests the certification authority to issue the digital certificate, the request including the acquired device identification information and management communication apparatus identification information; an issuance request receiving section that receives the request to issue the digital certificate; a certificate issuance section that authenticates the management communication apparatus by collating the identification information included in the request and the pre-registered identification information, and issues the digital certificate if the authentication is successful; and a certificate acquisition section that acquires from the certification authority the issued digital certificate if the authentication is successful.

According to another aspect of the present invention, the request for the digital certificate may include secret information shared between the management communication apparatus and the certification authority; and the secret information may be also pre-registered in the registration information memory section.

According to another aspect of the present invention, the certificate issuance request section may generate a private key and a public key, create signed issuance request by adding a signature based on the private key to information that includes the management communication apparatus identification information, the device identification information, and the public key, and transmit the signed issuance request; and the certificate issuance section may perform verification of the signature on the basis of the public key, perform collation of the received identification information of the management communication apparatus and the device with the pre-registered identification information, create a digital certificate by adding a signature of the certification authority to information that includes the received management communication apparatus identification information and the public key if verification of the signature and collation of the identification information are successful.

According to another aspect of the present invention, the certificate issuance request section may generate a private key and a public key, create signed issuance request by adding a signature based on the private key to information that includes the management communication apparatus identification information, the device identification information, and the public key, add secret information that has been installed in the management communication apparatus to the signed issuance request, and generate a hash value for information including the signed issuance request and the added secret information, and transmit the signed issuance request and the hash value; and the certificate issuance section may perform verification of the hash value on the basis of the secret information that has been pre-registered in the registration information memory section, verification of the signature on the basis of the public key, and collation of the received identification information of the management communication apparatus and the device with the pre-registered identification information, create a digital certificate by adding a signature of the certification authority to information that includes the received management communication apparatus identification information and the public key if verification of the hash value, verification of the signature, and collation of the identification information are successful, and transmit the created digital certificate.

According to another aspect of the present invention, the certificate issuance section, if the collation of the identification information is successful, may generate a private key and a public key, create a digital certificate by adding a signature of the certification authority to the received management communication apparatus identification information and the generated public key, and transmit the created digital certificate.

According to another aspect of the present invention, the certificate issuance request section may generate a hash value of the issuance request, and transmit the issuance request information and the hash value; and the certificate issuance section may perform verification of the hash value on the basis of the secret information that has been pre-registered in the registration information memory section and collation of the received identification information of the management communication apparatus and the device with the pre-registered identification information, generate a private key and a public key and create a digital certificate by adding a signature of the certification authority to information that includes the received management communication apparatus identification information and the public key if the verification of the hash value and the collation of the identification information are successful and transmit the created digital certificate.

According to another aspect of the present invention, the device may be a printing apparatus for forming images on a recording medium.

According to another aspect of the present invention, there is provided a certificate acquisition method in a system that includes a management communication apparatus that connects to a device and also connects via a network to a management center for managing the device, sends management information of the device to the management center, and acquires a digital certificate from a certificate authority, the method having: acquiring device identification information from the device; requesting the certification authority to issue a digital certificate, the request including the acquired device identification information and management communication apparatus identification information; performing authentication of the management communication apparatus by collating the identification information included in the request and identification information for the management communication apparatus and the device that should be connected, which has been pre-registered in the certification authority; and issuing a digital certificate if the authentication is successful.

According to another aspect of the present invention, the request for the digital certificate may include secret information shared between the management communication apparatus and the certification authority; and the secret information may be also pre-registered in the certificate authority.

According to another aspect of the present invention, there is provided a management communication apparatus, which connects to a device and also connects via a network to a management center for managing the device, acquires management information from the device, and sends the management information to the management center, having: an identification information acquisition section that acquires device identification information from the device; a certificate issuance request section that requests the certification authority to issue the digital certificate, the request including the acquired device identification information and management communication apparatus identification information; and a certificate acquisition section that acquires from the certification authority the digital certificate that is issued by the certification authority if the authentication is successful.

According to another aspect of the present invention, the request for the digital certificate may include secret information shared between the management communication apparatus and the certification authority.

According to another aspect of the present invention, there is provided a certification authority that issues a digital certificate to a management communication apparatus, which connects to a device and also connects via a network to a management center for managing the device, acquires management information from the device, and sends the management information to the management center, the certification authority having: a registration information memory section which pre-registers identification information for a management communication apparatus and a device that should be connected; an issuance request receiving section that receives a request to issue the digital certificate, the request including management communication apparatus identification information and device identification information from the management communication apparatus; and a certificate issuance section that authenticates the management communication apparatus by collating the identification information included in the request and the pre-registered identification information, and issues the digital certificate if the authentication is successful.

According to another aspect of the present invention, the request from the management communication apparatus may include secret information shared between the management communication apparatus and the certification authority; and the secret information may be also pre-registered in the registration information memory section.

According to another aspect of the present invention, there is provided a computer readable storage medium storing a program to be executed on a management communication apparatus, which connects to a device and also connects via a network to a management center for managing the device, acquires management information from the device, and sends the management information to the management center, the program causes the management communication apparatus to perform a function having: acquiring device identification information from a device; requesting a certification authority to issue the digital certificate, the request including the acquired device identification information and management communication apparatus identification information; and receiving from the certification authority the digital certificate that is issued by the certification authority if the authentication is successful.

According to another aspect of the present invention, the request for the digital certificate may include secret information shared between the management communication apparatus and the certification authority.

What is claimed is:

1. A certificate acquisition system which includes a management communication apparatus that connects to a device and also connects via a network to a management center for managing the device, acquires management information from the device, sends the management information to the management center, and requests for a digital certificate to a certification authority, the system comprising:
a registration information memory section which pre-registers identification information for a management communication apparatus and a device that should be connected;
an identification information acquisition section that acquires device identification information from the device;
a certificate issuance request section that requests the certification authority to issue the digital certificate, the request including the acquired device identification information and management communication apparatus identification information;
an issuance request receiving section that receives the request to issue the digital certificate;
a certificate issuance section that authenticates the management communication apparatus by collating the identification information included in the request and the pre-registered identification information, and issues the digital certificate if the authentication is successful; and
a certificate acquisition section that acquires from the certification authority the issued digital certificate if the authentication is successful.

2. The certificate acquisition system according to claim 1, wherein
the request for the digital certificate includes secret information shared between the management communication apparatus and the certification authority; and
the secret information is also pre-registered in the registration information memory section.

3. The certificate acquisition system according to claim 1, wherein:
the certificate issuance request section generates a private key and a public key, creates signed issuance request by adding a signature based on the private key to information that includes the management communication apparatus identification information, the device identification information, and the public key, and transmits the signed issuance request; and
the certificate issuance section performs verification of the signature on the basis of the public key, performs collation of the received identification information of the management communication apparatus and the device with the pre-registered identification information, creates a digital certificate by adding a signature of the certification authority to information that includes the received management communication apparatus identification information and the public key if verification of the signature and collation of the identification information are successful.

4. The certificate acquisition system according to claim 2, wherein:
the certificate issuance request section generates a private key and a public key, creates signed issuance request by adding a signature based on the private key to information that includes the management communication apparatus identification information, the device identification information, and the public key, adds secret information that has been installed in the management communication apparatus to the signed issuance request, and generates a hash value for information including the signed issuance request and the added secret information, and transmits the signed issuance request and the hash value; and
the certificate issuance section performs verification of the hash value on the basis of the secret information that has been pre-registered in the registration information memory section, verification of the signature on the basis of the public key, and collation of the received identification information of the management communication apparatus and the device with the pre-registered identification information, creates a digital certificate by adding a signature of the certification authority to information that includes the received management communication apparatus identification information and the public key if verification of the hash value, verification of the signature, and collation of the identification information are successful, and transmits the created digital certificate.

5. The certificate acquisition system according to claim 1, wherein:
the certificate issuance section, if the collation of the identification information is successful, generates a private key and a public key, creates a digital certificate by adding a signature of the certification authority to the received management communication apparatus identification information and the generated public key, and transmits the created digital certificate.

6. The certificate acquisition system according to claim 2, wherein:
the certificate issuance request section generates a hash value of the issuance request, and transmits the issuance request information and the hash value; and
the certificate issuance section performs verification of the hash value on the basis of the secret information that has been pre-registered in the registration information memory section and collation of the received identification information of the management communication apparatus and the device with the pre-registered identification information, generates a private key and a public key and creates a digital certificate by adding a signature of the certification authority to information that includes the received management communication apparatus identification information and the public key if the verification of the hash value and the collation of the identification information are successful and transmits the created digital certificate.

7. The certificate acquisition system according to claim 1, wherein the device is a printing apparatus for forming images on a recording medium.

8. A certificate acquisition method in a system that includes a management communication apparatus that connects to a device and also connects via a network to a management center for managing the device, sends management information of the device to the management center, and acquires a digital certificate from a certificate authority, the method comprising:
acquiring device identification information from the device;
requesting the certification authority to issue a digital certificate, the request including the acquired device identification information and management communication apparatus identification information;
performing authentication of the management communication apparatus by collating the identification information included in the request and identification information for the management communication apparatus and the device that should be connected, which has been pre-registered in the certification authority; and
issuing a digital certificate if the authentication is successful.

9. The certificate acquisition method according to claim 8, wherein
the request for the digital certificate includes secret information shared between the management communication apparatus and the certification authority; and
the secret information is also pre-registered in the certificate authority.

10. A management communication apparatus, which connects to a device and also connects via a network to a management center for managing the device, acquires management information from the device, and sends the management information to the management center, comprising:
an identification information acquisition section that acquires device identification information from the device;
a certificate issuance request section that requests the certification authority to issue the digital certificate, the request including the acquired device identification information and management communication apparatus identification information; and
a certificate acquisition section that acquires from the certification authority the digital certificate that is issued by the certification authority if the authentication is successful.

11. The management communication apparatus according to claim 10, wherein
the request for the digital certificate includes secret information shared between the management communication apparatus and the certification authority.

12. A certification authority that issues a digital certificate to a management communication apparatus, which connects to a device and also connects via a network to a management center for managing the device, acquires management information from the device, and sends the management information to the management center, the certification authority comprising:
a registration information memory section which pre-registers identification information for a management communication apparatus and a device that should be connected;
an issuance request receiving section that receives a request to issue the digital certificate, the request including management communication apparatus identification information and device identification information from the management communication apparatus; and
a certificate issuance section that authenticates the management communication apparatus by collating the identification information included in the request and the pre-registered identification information, and issues the digital certificate if the authentication is successful.

13. The certification authority according to claim 12, wherein
the request from the management communication apparatus includes secret information shared between the management communication apparatus and the certification authority; and
the secret information is also pre-registered in the registration information memory section.

14. A computer readable storage medium storing a program to be executed on a management communication apparatus, which connects to a device and also connects via a network to a management center for managing the device, acquires management information from the device, and sends the management information to the management center, the program causes the management communication apparatus to perform a function comprising:
acquiring device identification information from a device; requesting a certification authority to issue the digital certificate, the request including the acquired device identification information and management communication apparatus identification information; and
receiving from the certification authority the digital certificate that is issued by the certification authority if the authentication is successful.

15. The storage medium according to claim 14, wherein the request for the digital certificate includes secret information shared between the management communication apparatus and the certification authority.
